(19) United States
(12) Patent Application Publication
(10) Pub. No.: US 2018/0261970 A1
(43) Pub. Date: Sep. 13, 2018

(54) SHARED PUMP LASER

(71) Applicant: Southern Photonics Limited, Auckland (NZ)

(72) Inventor: Richard John PROVO, Auckland (NZ)

(73) Assignee: Southern Photonics Limited, Auckland (NZ)

(21) Appl. No.: 15/916,742

(22) Filed: Mar. 9, 2018

(30) Foreign Application Priority Data
Mar. 9, 2017 (NZ) 729928

(51) Int. Cl. H01S 3/08; H01S 3/067; H01S 3/091; G02F 1/35

(52) U.S. Cl. CPC H01S 3/08; G02F 1/3519; H01S 3/091; H01S 3/06791

(57) ABSTRACT

An arrangement for reducing the number of amplifier pumps required to energize gain sections in fiber lasers which incorporate nonlinear amplified loop mirrors.

### FIELD OF THE INVENTION

The invention generally relates to pulsed fiber lasers and in particular to an arrangement for reducing the number of amplifier pumps required to energize gain sections in fiber lasers which incorporate nonlinear amplified loop mirrors.

### BACKGROUND

A nonlinear amplified fiber optic loop mirror (NALM) can be used as a means of mode locking fiber optic lasers either in the normal or the anomalous dispersion regime. However, laser incorporating a NALM are restricted in power because a NALM may operate only at particular power levels. In order to increase the power of pulses output from a laser with a NALM, it is conventional to amplify the laser by using one or more additional gain sections and pump source at what may be considerable additional cost and complexity.

It is an object of the present invention to go at least some way toward overcoming the limitations of the prior art, or to provide the public with a useful choice. Other objects of the invention may become apparent from the following description which is given by way of example only.

### SUMMARY OF THE INVENTION

According to one embodiment, the invention consists in a laser apparatus comprising: a first component loop comprising at least a first gain component; a second loop comprising a fiber nonlinear amplified loop mirror (NALM), the NALM comprising a second gain component and coupled to the first component loop by a bidirectional optical coupling component; a first pump source operatively coupled to the first gain component in the first loop; a third gain component; a second pump component coupled to the third gain component then the second gain component and operative to sequentially pump both the third and second gain components; and wherein the second pump source is operable to pump the third gain component in excess of saturation such that surplus pump light is provided to the second gain component.

In some embodiments, the third gain component is located in the first component loop.

In some embodiments, the second pump source is configured to couple to the third gain component, be transmitted through the bidirectional optical coupling component to the second gain component.

In some embodiments, the first component loop further comprises an output coupler configured to couple at least some light to an output from the first component loop, and the third gain component is operatively couple to the output.

In some embodiments, the second pump source is configured to couple to the third gain component, be transmitted through the output coupler and bidirectional optical coupling component to the second gain component.

In some embodiments, the laser is constructed from all fiber components;

In some embodiments, the first loop further comprises: an optical isolator component; a length of single mode fiber; an output coupler component; and an optical filter component.

According to another aspect the invention consists in a method of operating a laser apparatus comprising a first component loop comprising at least a first gain component; a second loop comprising a fiber nonlinear amplified loop mirror (NALM), the NALM comprising a second gain component and coupled to the first component loop by a bidirectional optical coupling component; a first pump source component operatively coupled to the first gain component in the first loop; a third gain component; and a second pump source component coupled to the third gain component then the second gain component and operative to sequentially pump both the third and second gain components; wherein the method comprises: energizing the first pump source to supply pump light to the first gain component; and energizing the second pump component to supply pump light to the second and third gain components, the third gain component pumped in excess of saturation such that surplus pump light is provided to the second gain component.

According to another embodiment, the invention consists in a laser apparatus operable to generate giant chirp pulses, comprising optical fiber based components arranged to form a loop, the components comprising: a first amplifying section comprising a first gain section, a first pump source and a coupler configured to couple light from the first pump source to the first gain section, an optical isolator, a length of single mode fiber, a nonlinear amplified loop mirror passive mode locking device consisting of a gain section and a coupler configured to couple the mirror to the loop, a second amplifying section comprising a gain section, a second pump source and a coupler configured to couple light from the second pump source to the second gain section, an output coupler, and an optical filter, wherein the optical filter is configured between an output of the passive mode locking device and an input of the first gain medium to close the loop; and wherein the nonlinear amplified loop mirror is arranged to receive pump light from the second pump source, located outside of the NALM loop, in a bidirectional configuration.

According to another embodiment, the invention consists in a laser apparatus operable to generate giant chirp pulses, comprising optical fiber based components arranged to form a loop, the components comprising: a first amplifying section comprising a first gain section, a first pump source and a coupler configured to couple light from the first pump source to the first gain section, an optical isolator, a length of single mode fiber, a nonlinear amplified loop mirror passive mode locking device consisting of a gain section and a coupler configured to couple the mirror to the loop, an output coupler, and an optical filter connected to the input of the first amplifying section to close the loop, wherein the laser further comprises, on the outside of the loop, a second amplifying section comprising a gain section, a second pump source and a coupler configured to couple light from the second pump source to the second gain section, and wherein the nonlinear amplified loop mirror is arranged to receive pump light from the second pump source in a bidirectional configuration.

According to another embodiment, the invention consists in a laser apparatus comprising: a nonlinear amplified loop mirror; and a pump source located outside for the loop mirror configured to transmit pump light into the loop mirror.

A laser apparatus wherein the second pump source is configured to pump a gain section located outside of the nonlinear amplified loop mirror.

According to another embodiment, the invention consists in a laser apparatus operable to generate giant chirp pulses, comprising: optical fiber based components arranged to form a loop, the components arranged in a unidirectional sequence of: a first gain medium, a length of single mode fiber, a nonlinear loop mirror passive mode locking device consisting of a gain section and a coupler configured to couple the mirror to the loop, a second amplifying section comprising a gain section, a second pump source and a coupler configured to couple light from the second pump source to the second gain section, an output coupler, and an optical filter optically coupled to the first gain medium to close the unidirectional sequence, wherein the loop further comprises an optical isolator located between the first gain medium and the passive mode locking device in the unidirectional sequence, and wherein the optical isolator is oriented to configure the giant chirp pulses to follow the unidirectional sequence, and wherein the nonlinear amplified loop mirror is arranged to receive pump light from at least the second pump source in a bidirectional configuration.

According to another embodiment, the invention consists in a laser apparatus operable to generate giant chirp pulses, comprising: optical fiber based components arranged to form a loop, the components arranged in a unidirectional sequence of: a first amplifying section comprising a first gain section, a first pump source and a coupler configured to couple light from the first pump source to the first gain section, a length of single mode fiber, a nonlinear loop mirror passive mode locking device consisting of a gain section and a coupler configured to couple the mirror to the loop, a second amplifying section comprising a gain section, a second pump source and a coupler configured to couple light from the second pump source to the second gain section, an output coupler, and an optical filter optically coupled to the first gain medium to close the unidirectional sequence, wherein the laser further comprises, on the outside of the loop, a second amplifying section comprising a gain section, a second pump source and a coupler configured to couple light from the second pump source to the second gain section, and wherein the nonlinear amplified loop mirror is arranged to receive pump light from at least the second pump source in a bidirectional configuration.

As used herein the term “and/or” means “and” or “or”, or both. As used herein “(s)” following a noun means the plural and/or singular forms of the noun. The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

To those skilled in the art to which the invention relates, many changes in construction and widely differing embodiments and applications of the invention will suggest themselves without departing from the scope of the invention. The disclosures and the descriptions herein are purely illustrative and are not intended to be in any sense limiting.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### BRIEF DESCRIPTION OF THE DRAWINGS

The invention will now be described by way of example only and with reference to the drawings in which:

FIG. 1 is a schematic of a laser representing the state of the prior art.

FIG. 2 is a schematic of an example laser according to a first embodiment.

FIG. 3 is a schematic of an example laser according to a second embodiment.

FIG. 4 shows a single pump source being split to provide energize multiple gain mediums of the first and second embodiments.

### DETAILED DESCRIPTION OF THE INVENTION

A NALM is a device comprising a gain section and a central optical coupler to which it is optically connected to other optical components. Conventional practice is to provide pump light to the gain section of the NALM from a wavelength division multiplexing (WDM) coupler which is configured inside the NALM loop.

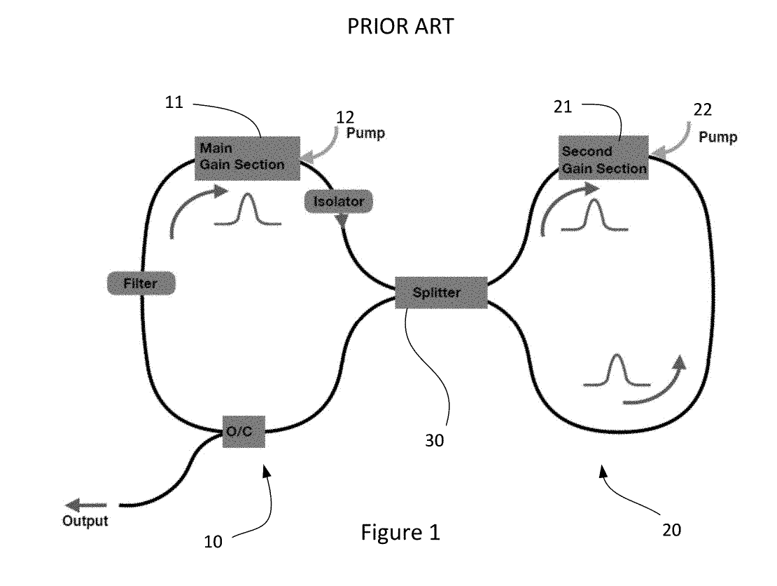

FIG. 1 shows the arrangement of components of a laser published in WO2013/187774, the entirety of which is incorporated by reference, which is operable to generate a pulsed laser output suitable for a variety of uses. Preferred embodiments of the invention discussed herein relate to an evolution of the laser described in WO2013/187774.

The laser shown in FIG. 1 has two loops, a first loop 10 and a second loop 20 which are coupled by a splitter 30. The second loop 20 forms a NALM. The amplifying portion of a NALM typically comprises a section of gain fiber energized by a suitable pump source. The pump is a source of light of a particular wavelength and typically coupled to the section of gain fiber through a wavelength division multiplexer (WDM), not shown, which is inserted into the NALM loop. For example, the laser of FIG. 1 is an all fiber laser with a NALM operating to mode lock the laser and provide some amplification to the propagating pulse. In particular, the laser of FIG. 1 has a first main gain section 11 in the main laser loop 10 pumped by a first pump source 12, and the NALM contains a second gain component 21 pumped by a second pump source 22. The gain components 11, 21 are typically doped fibers such as Erbium or Ytterbium doped fibers pumped by a light source of about 900 nm.

A gain component can be provided by a number of different devices such as a single mode fiber, Ytterbium (Yb), an Erbium (Er), Neodymium, Holmium other rare-earth doped fibers. Those skilled in the art will appreciate the particular gain component used will be related to the desired output wavelength of the pulses to be generated and sustained by the laser cavity. Further, those skilled in the art will appreciate a pump source characteristics required to enable a particular fiber to act as a gain component will depend on the particular characteristics of the gain component selected.

For example, if the desired output wavelength is around 1 micrometer, the potential rare-earth doped fibers gain component that are operable to provide amplification at this wavelength are Ytterbium, or Neodymium doped fibers as they provide amplification of light around 1 micrometer. For example, if the desired output wavelength is around 1.5 micrometers, an Erbium-doped fiber would provide amplification around this wavelength provided that suitable normal dispersion fibers at that wavelength were used. Similarly, if the desired output wavelength is around 2 micrometers, a Thulium or Holmium-doped fiber would provide amplification. A rare earth-doped fiber may also be considered to be a preferable gain component as they usually provide greater amplification compared to a single-mode fibers (using Raman or parametric gain).

One limitation of the laser of FIG. 1 is the maximum output power that can be achieved, which is about 15 nJ. The power limitation is determined by the operating conditions of the NALM loop—which may operate only at particular power levels. Increasing the level of amplification of either the first gain section GF1 or the second gain section in the NALM GF2 beyond 15 nJ is detrimental to the performance of the laser. In order to increase the power of pulses output from this laser, it is conventional to provide an additional gain section and pump source. However, the component cost for a suitable pump source is considerable and may be as much or more than the rest of the components used to construct the laser.

Further, gain fibers should be pumped by light with a wavelength not more than 0.5 nm from the optimum gain fiber absorption wavelength for efficient operation. Pump sources generate significant amounts of heat and therefore require strict temperature stabilization in order to prevent the output frequency from drifting. In addition to avoiding cost and additional components to support additional pumps, it is advantageous to avoid further pump sources in what is often a compact laser product, which may suffer detrimentally from too many heat generating sources within a given enclosure.

In embodiments of the invention discussed herein, a laser is provided that is operable to generate much more power than the laser depicted by FIG. 1. In addition, the number of pump light sources is reduced which offers advantages including fewer components, a lower cost of construction and reduced cavity tuning complexity. Another advantage that has been realized is more efficient operation of the gain providing components due to bidirectional pumping.

In embodiments of the invention discussed herein, there is a laser that includes a NALM and pump light is provided to a NALM through the central optical coupler used to connect the NALM to other optical components in the laser. Further, that pump light is shared with one or more other gain sections located outside of the NALM. The NALM therefore does not have a WDM coupler within the NALM loop itself or pump light provided directly to the gain section in the NALM itself.

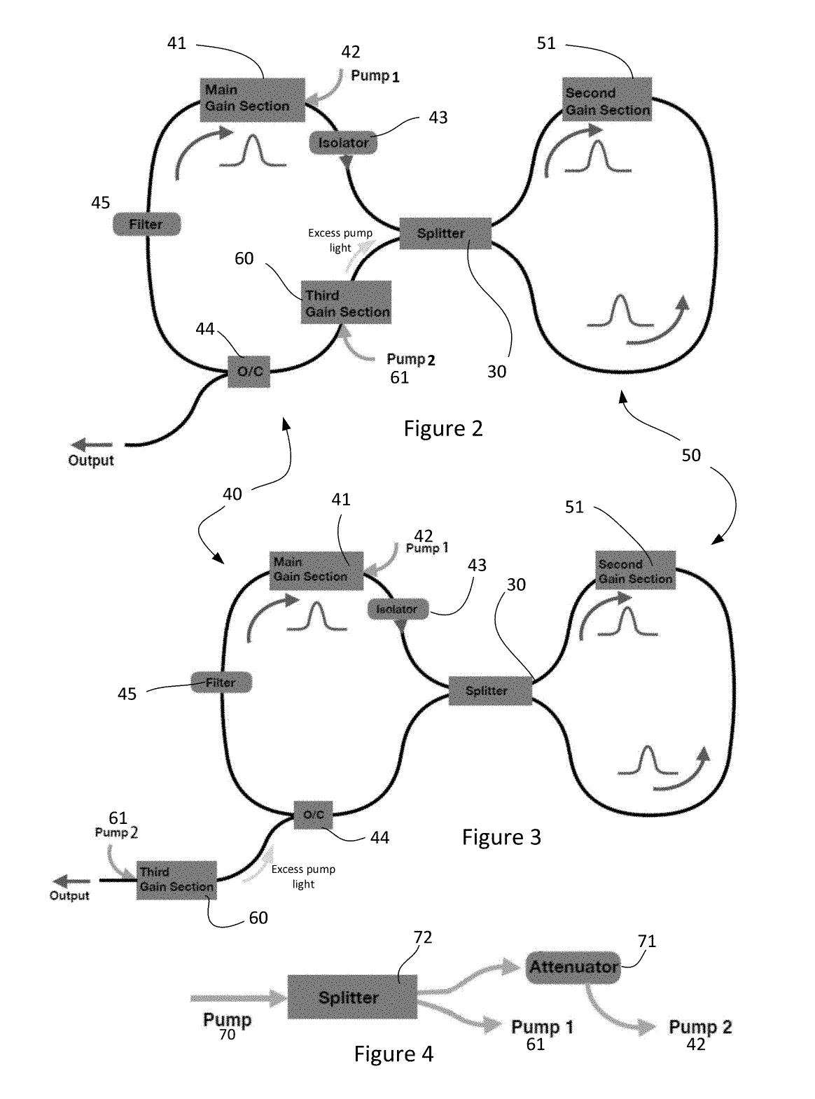

As mentioned, one advantage embodiments of the invention provide is avoiding the requirement for an additional pump source and WDM coupler dedicated to the gain section of the NALM. A pump associated with an external amplifier, which is always required at the output of the laser to amplify the output pulses, is also used to supply the gain component of the NALM whilst also pumping the amplifier at the laser output. However, other significant advantages are also realized and are discussed below. The advantages can be realized either by adding a WDM and associated gain section in the main laser loop instead of in the NALM loop as discussed below with reference to the embodiment depicted by FIG. 2, or by putting a WDM and associated gain section on the output of the laser (outside the main loop) and pumping the NALM loop through the output coupler as discussed below with reference to the embodiment depicted by FIG. 3.

In a first exemplary embodiment, there is provided a fiber loop laser having three gain sections in the loop pumped by two pump sources, where one of the three gain sections forms part of a NALM. In a second exemplary embodiment, there is provided a fiber loop laser having two gain sections inside a loop, where one of these two gain sections forms part of a NALM, and a third gain section outside the loop. The three gain sections are again energized by two pump sources.

In the first exemplary embodiment, a loop laser is provided comprising a first gain section, a NALM comprising a second gain section, and a third gain section. The first and third gain sections are located outside the NALM. The first and third gain section are configured to receive pump light from respective pump sources via a WDM coupler in the conventional way. However, the direction of the pump source supplying the first and third gain sections is orientated such that pump light exiting the first and third gain sections propagates through the loop in opposing directions, and toward the NALM.

However, optimal performance is realized when the first gain section is pumped below saturation and no or minimal pump light exists the first gain section. This is to avoid phenomena such as multiple pulse propagation and Q-switching. Further, the third gain section is pumped with surplus light to ensure saturation of the third gain section and to ensure sufficient pump light exits the third gain section to be split by the central coupler of the NALM and provides bidirectional pumping of the second gain section inside the NALM. This arrangement not only ensures bidirectional pumping of the NALM gain section, but also provides for increased power output from the laser itself, as the pulse exiting the NALM is amplified before the output coupler.

Bidirectional pumping of the gain section in the NALM leads to the abovementioned additional advantages—it has been discovered that operational performance of the NALM is improved due to uniform population inversion inside the gain section of the NALM. A further advantage is that the NALM loop can be shortened due to the improved operational performance.

FIG. 2 shows an exemplary configuration of a laser that accords with the first embodiment. The laser comprises a main loop 40 comprising fiber based optical components. The components are in a sequence of: a first gain component 41 pumped by a pump source 42 via a coupler; an optical isolator 43 that acts to set operational direction of the loop; a NALM 50 comprising a second gain component 51 and a coupler/splitter 30 to optically connect the NALM to the main loop; a third gain component 60 pumped by a second pump source 61 configured to send pump light in a direction around the loop that opposes that of the first pump source; an output coupler 44 for coupling light from the loop; and an optical filter 45 configured to connect back to the first gain component 41 to close the loop.

It should be understood that the location of the isolator 43 could be anywhere in the loop, however it is most preferable to locate the isolator between the first gain section 41 and the third gain section 60 relative to the propagation direction of the loop. Further, the filter 45 could also be placed anywhere in the loop, however it is preferable to locate the filter after the output coupler, and between the third gain component 60 and the first gain component 41 relative to the propagation direction of the loop.

The component arrangement of the laser depicted in FIG. 2 enables the insertion of the third gain section 60 without the addition of a third pump device. By ensuring that the third gain section 60 is saturated with pump light and that sufficient pump light is transmitted through it to continue through the loop, that excess pump light will also reach and pump the NALM gain section 51. The addition of the third gain component 60 substantially increases the output power of the laser beyond what was possible with the prior art laser.

The length of the third gain component 60 can vary from zero to several meters depending on the doping level of the fiber and the output power desired. It is essential to adjust the pump power though the pump coupling component so that the third gain component 60 is oversaturated such that there is sufficient pump energy passed through the third gain medium and transmitted to energize the NALM 50. That is, so that the second pump 61 sequentially pumps the third then second gain components.

FIG. 3 shows another exemplary configuration of a laser that accords with the second embodiment. The laser comprises a main loop 40 comprising fiber based optical components. The components are in a sequence of: a first gain component 41 pumped by a pump source 42 via a coupler WDM1; an optical isolator 43 that acts to set operational direction of the loop; a NALM 50 comprises a second gain section 51 and a coupler/splitter 30 to optically connect the NALM 50 to the main loop 40; an output coupler 44 for coupling light from the loop 40 is provided after the NALM 50; finally, an optical filter 45 is configured to connect back to the first gain section to close the loop. On the output of the output coupler 44 is a third gain section 60 pumped by a second pump source 61 configured to send pump light in a direction around the loop that opposes that of the first pump source 42. The second pump 61 is coupled to the third gain component 60 by a WDM coupler which also provide an operational output from laser.

It should be understood that the location of the isolator 43 could be anywhere in the main loop 40.

For each of the above described embodiments, the central coupler 30 provided as part of the NALM 50 can be from 50/50 to 60/40 in split ratio.

The third gain component 60 is optionally added to the laser to increase the output power. The third gain component 60 can be located in either the main laser loop 40 as shown in FIG. 2 or outside the main loop 40 as shown in FIG. 3. In the example embodiments shown, the output energy can be amplified up to powers of 150 mW, a significant increase over the 15 mW power previously attainable and without the additional cost and complexity over previously known amplification methods.

Putting the third gain component 60 inside the main laser loop 40 enables all the pump power from the pump configured to pump the third gain component 60 to be used for the third and second gain components, but can lead to excessive power circulating in the main laser loop 40.

Putting the third gain component outside the laser loop and separating the preamplifier from the laser can enable higher output power, but some of the second pump laser power is then lost though the output coupler (but typically only 20% if the output coupler 44 is 80/20). Both configurations retain the advantage of using only one pump laser to power the NALM loop and the third gain component 60.

The third gain component can be between zero and several meters in length depending upon the dopant level in the gain fiber and the power of the pump laser. Once again, the pump source for the third gain component is configured to pump the third gain component beyond saturation to ensure ample pump light is emitted from the third gain section and to the NALM gain section 51.

It should be noted that pump light provided to the NALM 50 from the second pump source 61 may be redirected toward and re-enter the second pump 42 after propagating through the NALM 50. In some embodiments, an isolator may be present on the output of the second pump component to prevent re-entry of pump light.

It should further be noted that start-up and operational stability are optimized when the power levels of the two pump sources 61, 42 are controllable. Whilst further variations of the above described embodiments are envisaged where the output of a single pump source is split a directed to two or more fiber gain sections, it is noted that control over startup and operational stability is compromised. However, locating a variable attenuation device on each split from a single pump source may go at least some way toward recovering control over optimum startup and operational stability.

FIG. 4 illustrates how a single pump source 70 is split to facilitate the first pump source 61 and second pump source 42. A single pump source may be used in this way with the first and second embodiments. A splitter component 72 is configured to receive light from the singular pump source 70 and output the pump source in two paths, the first pump source path 61 and the second pump source path 62. To adjust the pump energy provided to each of the three gain mediums, a splitter component 71 is arranged to divide the pump energy into two paths. The splitter may be configured with a ratio that provides a desired amount of light to each path according to the desired amount of pump light to be provided to each of the gain components, and an adjustable attenuator 71 may be placed in either one of the output paths.

Where an adjustable attenuator 71 is used, as depicted, it may be in either path, and the magnitude of attenuation balanced with the output power of the pump 70 to thereby provide the desired output power to each of the first and second pump paths. Whilst dependent on the particular gain components used, the second pump path will typically require the most pump energy since that energy is provided to two gain mediums, whereas the first pump source 42 supplies only a single gain component. Therefore, it may be most advantageous to locate the attenuator in the pump path that requires the least energy, that is, the first pump path. Similarly, an attenuator may be located at each output of the splitter for control of the pump power provided to each pump source. However, it is most important that stable pumping of the laser operation is stable and that is achieved by accurate control of the pump energy provided to each pump path. Therefore an attenuator 71 may be located in either pump path.

It is further envisaged that a single pump may be divided into three or more paths and provided independently to each gain component, typically with an adjustable attenuator in at least two paths, or at least splitter ratio matched to the pump energy requirements of each gain medium. However, the advantages of the invention in this configuration are diminished by the requirement for additional splitter and attenuator components, and the increased complexity of balancing three pump source paths.

Where in the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope or spirit of the invention.

1. A laser apparatus comprising:
a first component loop comprising at least a first gain component;
a second loop comprising a fiber nonlinear amplified loop mirror (NALM), the NALM comprising a second gain component and coupled to the first component loop by a bidirectional optical coupling component;
a first pump source operatively coupled to the first gain component in the first loop;
a third gain component;
a second pump component coupled to the third gain component then the second gain component and operative to sequentially pump both the third and second gain components; and
wherein the second pump source is operable to pump the third gain component in excess of saturation such that surplus pump light is provided to the second gain component.

2. The laser apparatus as claimed in claim 1, wherein the third gain component is located in the first component loop.

3. The laser apparatus as claimed in claim 2, wherein the second pump source is configured to couple to the third gain component, be transmitted through the bidirectional optical coupling component to the second gain component.

4. The laser apparatus as claimed in claim 1, wherein the first component loop further comprises an output coupler configured to couple at least some light to an output from the first component loop, and the third gain component is operatively couple to the output.

5. The laser apparatus as claimed in claim 4, wherein the second pump source is configured to couple to the third gain component, be transmitted through the output coupler and bidirectional optical coupling component to the second gain component.

6. The laser apparatus as claimed in claim 1, wherein the laser is constructed from all fiber components.

7. The laser apparatus as claimed in claim 1, wherein the first loop further comprises:
an optical isolator component;
a length of single mode fiber;
an output coupler component; and
an optical filter component.

8. The laser apparatus as claimed in claim 1, wherein the laser apparatus comprises a single pump component and a splitter component configured to receive and divide pump light from the single pump component into at least the first pump source and the second pump source.

9. The laser apparatus as claimed in claim 8, wherein the laser apparatus comprises an adjustable attenuator located after the splitter component and before either the first pump source or the second pump source; the adjustable attenuator operable to control pump energy provided to the first or second pump source.

10. A method of operating a laser apparatus comprising a first component loop comprising at least a first gain component; a second loop comprising a fiber nonlinear amplified loop mirror (NALM), the NALM comprising a second gain component and coupled to the first component loop by a bidirectional optical coupling component; a first pump source component operatively coupled to the first gain component in the first loop; a third gain component; and a second pump source component coupled to the third gain component then the second gain component and operative to sequentially pump both the third and second gain components;
wherein the method comprises:
energizing the first pump source to supply pump light to the first gain component; and
energizing the second pump component to supply pump light to the second and third gain components, the third gain component pumped in excess of saturation such that surplus pump light is provided to the second gain component.
